(19) United States
(12) Patent Application Publication
(10) Pub. No.: US 2025/0110785 A1
(43) Pub. Date: Apr. 3, 2025

(54) Simulating a Transition Between Operating Domains to Optimize Device Resource Utilization

(71) Applicant: Google LLC, Mountain View, CA (US)

(72) Inventors: Tyler Christian Gore, Cupertino, CA (US); Anuradha Sampath Kumar, San Diego, CA (US); Steven B. Diamond, San Francisco, CA (US); Timothy Warren Kryger, San Francisco, CA (US)

(21) Appl. No.: 18/484,205

(22) Filed: Oct. 10, 2023

Related U.S. Application Data
(60) Provisional application No. 63/587,670, filed on Oct. 3, 2023.

(51) Int. Cl. G06F 9/50

(52) U.S. Cl. CPC G06F 9/5027

(57) ABSTRACT

While operating in a low-power operating domain that utilizes a low-power processor device, a mobile computing device causes display of a low-power operating domain interface. The mobile computing device makes a determination that a user intends a particular type of interaction that requires the mobile computing device to operate in a high-performance operating domain that utilizes a high-performance processor device. The mobile computing device performs initial process(es) of a plurality of domain-switching processes that are performed to switch the mobile computing device from the low-power operating domain to the high-performance operating domain. Responsive to the determination, the mobile computing device causes display of a high-performance operating domain interface.

### PRIORITY CLAIM

The present application claims priority to, and the benefit of, U.S. Provisional Patent Application 63/587,670. Applicant incorporates the application herein by reference in its entirety.

### FIELD

The present disclosure relates generally to optimizing device resource utilization. More particularly, the present disclosure relates to simulating a transition from a low-power operating domain to a high-performance operating domain to optimize resource utilization.

### BACKGROUND

Recent advancements in processor design have enabled additional capabilities in a variety of modern computing devices (e.g., smartphones, smart watches, wireless earbuds, Augmented Reality (AR)/Virtual Reality (VR) devices, etc.). In particular, many computing devices include multiple processor devices that are designed to operate in different operating domains (i.e., “compute” domains, etc.). For example, a wearable computing device (e.g., a “smart-watch,” a Mixed Reality (MR) device, etc.) can include a “low-power” processor device designed to utilize substantially less power than a conventional processor device, thus enabling the device to operate in a low-power operating domain. The wearable computing device can also include a “high-performance” processor device designed to perform computationally expensive operations, thus enabling the device to operate in a high-performance operating domain. By dynamically switching between these operating domains, the mobile computing device can reduce compute resource expenditure while retaining the capability to perform computationally expensive operations.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method performed by a mobile computing device comprising a plurality of processor devices. While operating in a low-power operating domain that utilizes a low-power processor device of the plurality of processor devices, the method includes causing, by the mobile computing device with the low-power processor device, display of a low-power operating domain interface via a display device associated with the mobile computing device. While operating in the low-power operating domain, the method includes making, by the mobile computing device with the low-power processor device, a determination that a user of the mobile computing device intends a particular type of interaction with the mobile computing device that requires the mobile computing device to operate in a high-performance operating domain that utilizes a high-performance processor device of the plurality of processor devices. While operating in the low-power operating domain, the method includes, responsive to the determination, performing, by the mobile computing device with the low-power processor device, one or more initial domain-switching processes of a plurality of domain-switching processes that are performed to switch the mobile computing device from the low-power operating domain to the high-performance operating domain. While operating in the low-power operating domain, the method includes, responsive to the determination, causing, by the mobile computing device with the low-power processor device, display of a high-performance operating domain interface via the display device associated with the mobile computing device.

Another example aspect of the present disclosure is directed to a computing system. The computing device includes a plurality of processor devices comprising a high-performance processor device and a low-power processor device, wherein the high-performance processor device is utilized when the computing device is operating in a high-performance operating domain, and wherein the low-power processor device is utilized when the computing device is operating in a low-power operating domain. The computing device includes one or more computer-readable media that collectively store instructions that, when executed by one or more of the plurality of processor devices, cause the computing device to perform operations. The operations include, while operating in the low-power operating domain, causing, with the low-power processor device, display of a low-power operating domain interface via a display device associated with the computing device. The operations include, while operating in the low-power operating domain, detecting, with the low-power processor device, occurrence of an intermediate operating domain switch condition. The operations include, responsive to detecting the occurrence of the intermediate operating domain switch condition, switching to an intermediate operating domain. Switching to the intermediate operating domain comprises performing one or more initial domain-switching processes of a plurality of domain-switching processes that are performed to switch the mobile computing device to the high-performance operating domain. Switching to the intermediate operating domain comprises causing display of a high-performance operating domain interface via the display device associated with the mobile computing device.

Another example aspect of the present disclosure is directed to one or more computer-readable media that collectively store instructions that, when executed by one or more of a plurality of processor devices of a computing device, cause the computing device to perform operations. The operations include, while operating in a low-power operating domain that utilizes a low-power processor device of the plurality of processor devices, causing, with the low-power processor device, display of a low-power operating domain interface via a display device associated with the computing device. The operations include, while operating in the low-power operating domain, making, with the low-power processor device, a determination that a user of the computing device intends a particular type of interaction with the computing device that requires the computing device to operate in a high-performance operating domain that utilizes a high-performance processor device of the plurality of processor devices. The operations include, while operating in the low-power operating domain and responsive to the determination, performing, with the low-power processor device, one or more initial domain-switching processes of a plurality of domain-switching processes that are performed to switch the computing device from the low-power operating domain to the high-performance operating domain. The operations include, while operating in the low-power operating domain and responsive to the determination, causing, with the low-power processor device, display of a high-performance operating domain interface via the display device associated with the computing device.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIGS. 1, 2, and 3 each illustrate a perspective view of an example, non-limiting wearable device according to one or more example embodiments of the present disclosure.

FIG. 4A illustrates a block diagram of the above-described example, non-limiting wearable device according to one or more example embodiments of the present disclosure.

FIG. 4B illustrates a block diagram of the control circuitry of the above-described example, non-limiting wearable device according to one or more example embodiments of the present disclosure.

FIG. 5 illustrates a diagram of an example, non-limiting user assessment management system according to one or more example embodiments of the present disclosure.

FIG. 6 depicts a flow chart diagram of an example method to perform according to example embodiments of the present disclosure.

FIGS. 7A-7C are data flow diagrams for reducing perceivable operating domain switching latency by simulating a transition between operating domains for a mobile computing device at times T1-T3 according to some implementations of the present disclosure.

Reference numerals that are repeated across plural figures are intended to identify the same features in various implementations.

### DETAILED DESCRIPTION

### Overview

Generally, the present disclosure is directed to optimizing device resource utilization. More particularly, the present disclosure relates to simulating a transition from a low-power operating domain to a high-performance operating domain to optimize resource utilization. As described previously, advancements in processor design have enabled additional capabilities in a variety of modern computing devices (e.g., smartphones, smart watches, wireless earbuds, Mixed Reality (MR) devices, etc.). In particular, many computing devices include multiple processor devices that are designed to operate in different operating domains (i.e., “compute” domains, etc.). To do so, devices can include multiple types of processor devices, such as “low-power” processor devices and “high-performance” processor devices. Low-power processor devices can be designed to utilize substantially less power than a conventional processor device, thus enabling a computing device to operate in a low-power operating domain. Conversely, high-performance processor devices can be designed to perform computationally expensive operations, thus enabling a computing device to operate in a high-performance operating domain.

A computing device that includes both a low-power processor device and a high-performance processor device can leverage both devices to substantially optimize resource utilization while preserving the capability to perform computationally expensive operations. For example, assume that the computing device is a smartwatch device that provides “always-on” functionality in which a display device of the smartwatch always displays some manner of information. To do so, the smartwatch can enter a low-power operating domain in which the low-power processor device is utilized to cause display of a low-power operating domain interface. If the smartwatch determines that a user intends a particular type of interaction with the smartwatch (e.g., executing an application, adjusting device settings, providing an input, etc.), the smartwatch can switch from the low-power operating domain to a high-performance operating domain. The high-performance operating domain can utilize a high-performance processor device to cause display of a high-performance operating domain interface. By operating in the low-power operating domain by default, the smartwatch can substantially reduce battery resource utilization.

However, such an approach presents a variety of problems. As one example, switching between operating domains generally causes a perceptible delay, thus reducing the quality of the user experience. In response, many conventional devices pre-emptively switch operating domains from the low-power operating domain to the high-performance operating domain based on a prediction that a user is likely to interact with the device in a manner that requires the high-performance operating domain. To follow the previous example, if a user brings the smartwatch level with their face, the smartwatch can predict that the user is likely to interact with the device in a manner that requires the high-performance operating domain and, based on the prediction, pre-emptively switch to the high-performance operating domain. However, users often perform these actions without actually intending to interact with the device in a manner that requires the high-performance operating mode. As such, a large proportion of pre-emptive domain-switching is unnecessary, which in turn substantially reduces the battery resource optimization provided by the low-power operating domain.

Accordingly, implementations of the present disclosure propose simulating a switch, or transition, between operating domains to optimize device resource utilization. More specifically, a mobile computing device (e.g., a smartwatch, a smartphone, a wearable device, etc.) can enter a low-power operating domain that utilizes a low-power processor device. With the low-power processor device, the computing device can cause display of a low-power operating domain interface via a display device associated with the mobile computing device. For example, the low-power operating domain interface can be an interface that is updated less frequently and is displayed with reduced brightness and a reduced refresh rate.

The mobile computing device can make a determination that a user of the mobile computing device intends a particular type of interaction that requires that requires the device to operate in the high-performance operating domain that utilizes the high-performance processor device. For example, the mobile computing device can make the determination based on the user raising the mobile computing device to their face, entering a certain location, occurrence of a certain time of day, occurrence of a scheduled reminder, etc.

Based on the determination, the mobile computing device can perform one or more initial domain-switching processes of a plurality of domain-switching processes that are performed to switch the mobile computing device from the low-power operating domain to the high-performance operating domain. The initial domain-switching process(es) can be processes that can be performed with the low-power processor device. For example, a domain-switching process that retrieves and processes data via a wireless network connection may be too computationally expensive to perform with the low-power processor device. However, adjusting the polling rate of a sensor can be an initial domain-switching process that is performable with the low-power processor device.

Based on the determination, the mobile computing device can cause display of a high-performance operating domain interface with the low-power processor device. In this manner, although the mobile computing device has not switched to the high-performance operating domain interface and is still utilizing the energy efficient low-power processor device, the user will perceive the mobile computing device as already having switched between operating domains. Additionally, by performing initial domain-switching process(es), the computing device can reduce, or eliminate, the perceptible delay caused by switching operating domains.

Aspects of the present disclosure provide a number of technical effects and benefits. As one example technical effect and benefit, implementations of the present disclosure substantially optimize battery utilization for mobile computing devices. Specifically, as described previously, conventional mobile devices must pre-emptively switch from a low-power operating domain to a high-performance operating domain to fulfill user expectations. In turn, this substantially reduces the amount of time spent by the device in the low-power operating domain. This problem is exacerbated in certain types of devices, such as smartwatches, as users will often indicate intent (e.g., by raising their arm) without actual intent to utilize the operating domain. However, implementations of the present disclosure can simulate the transition to the high-performance operating domain while remaining in the low-power operating domain, thus fulfilling user expectations while eliminating the substantial resource expenditure associated with pre-emptively switching to the high-performance operating domain.

Further, computing devices such as smart watches can accentuate the differences between different compute domains. For example, a low-power compute domain presents a completely different UX and set of possible interactions relative to the high power domain. The act of switching from a low-power domain to a high-power domain requires educating the user on the different capabilities in each domain, and the UX creates an obvious distinction during this transition. This is required for two distinct reasons: 1) Low-power compute domains are inherently less capable and 2) The latency of switching from the low-power to high-performance compute domain is large enough to be visible to the user.

In addition, a low-power compute domain presents a completely different UX and set of possible interactions relative to the high-performance domain. The act of switching from a low-power domain to a high-performance domain requires educating the user on the different capabilities in each domain, and the UX creates an obvious distinction during this transition. This is required for two distinct reasons: 1) Low-power compute domains are inherently less capable and 2) The latency of switching from the low-power to high-performance compute domain is large enough to be visible to the user. Given two primary compute domains: 1) Interactive and 2) Ambient, implementations described herein provide a seamless experience to the user when switching between them.

Each of these domains has the ability to drive the display(s) that a user sees on a device by way of a switch that selects between which domain is currently controlling the device, or by a controller integrated into the display that can receive inputs from two or more domains. One cause for a user to switch from the Ambient domain to the Interactive domain is due to physical interaction with the screen, buttons, rotating crown, voice input, or gesture. The acceptable latency to respond to a user input is typically given relative to the display frame rate, but it is important to note that it is less than or equal to the time it takes for a high-power Interactive compute domain to power up and to be ready to process these inputs and respond to them.

Thus, by performing the following operations, implementations described herein can reduce, eliminate, or otherwise make imperceptible, the transition from one operating domain to another by:
configuring input devices in different modes depending on the system state, and moving some algorithms for input detection to the peripherals themselves (touch controller, for example)
Using the Ambient domain to display realtime information to the user (as if it was in Interactive) where appropriate
using algorithms that run in the Ambient domain to detect potential times a user will interact with the device
pre-warming sub-systems when a user may transition to Interactive to reduce wake latency
optimizing wake-up and sleep paths for Interactive compute domain.

With reference now to the Figures, example embodiments of the present disclosure will be discussed in further detail.

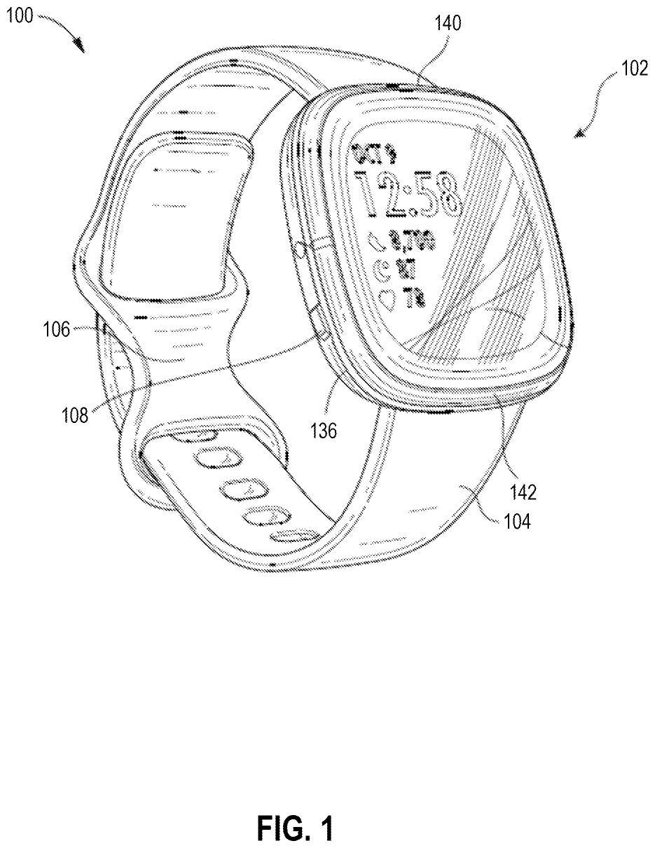

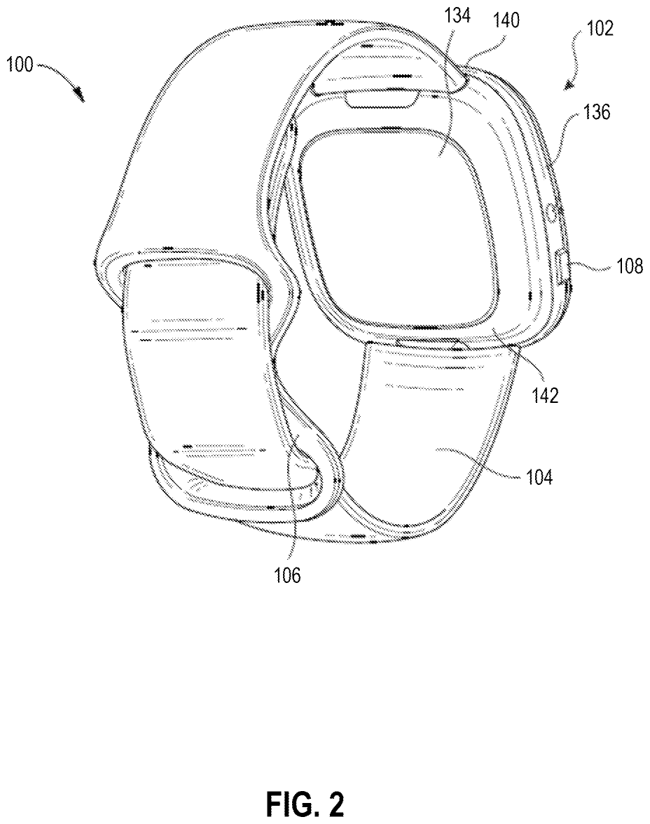

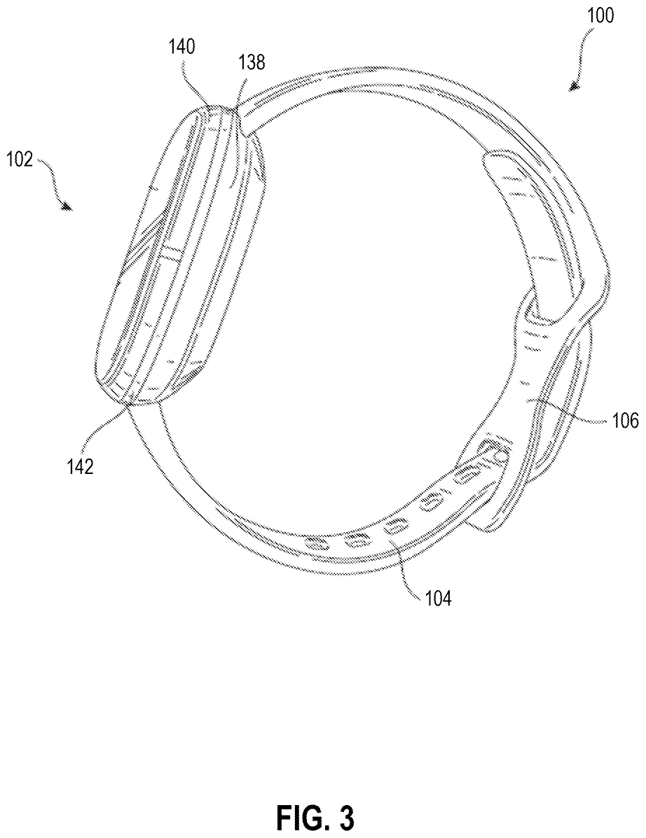

In one or more embodiments, the computing device described above and below according to example embodiments of the present disclosure can constitute, include, be coupled to, and/or otherwise be associated with one or more computing devices and/or computing systems described below and illustrated in the example embodiments depicted in FIGS. 1, 2, 3, 4, 5, and/or 6. For example, in at least one embodiment, the computing device described above and below according to example embodiments of the present disclosure can constitute, include, be coupled to, and/or otherwise be associated with wearable device 100, 100a, 100b, and/or 100c, external computing device 504, 504a, 504b, and/or 504c, and/or server system 604.

FIGS. 1, 2, and 3 each illustrate a perspective view of an example, non-limiting computing device (e.g., wearable computing device) 100 according to one or more example embodiments of the present disclosure. In example embodiments described herein, wearable device 100 can constitute and/or include a wearable computing device. For instance, in these or other example embodiments, wearable device 100 can constitute and/or include a wearable computing device such as, for example, a wearable physiological monitoring device that can be worn by a user (also referred to herein as a “wearer”) and/or capture one or more types of physiological data of the user (e.g., heart rate (HR) data, motion data (e.g., accelerometer data), body temperature data, respiration rate data, blood pressure data, blood oxygenation level data, deoxyribonucleic acid (DNA) data, electrodermal activity (EDA) data, stress related data).

Wearable device 100 according to example embodiments of the present disclosure can include a display 102, an attachment component 104, a securement component 106, and a button 108 that can be located on a side of wearable device 100. In at least one embodiment, two sides of display 102 can be coupled (e.g., mechanically, operatively) to attachment component 104. In some embodiments, securement component 106 can be located on, coupled to (e.g., mechanically, operatively), and/or integrated with attachment component 104. In these or other embodiments, securement component 106 can be positioned opposite display 102 on an opposing end of attachment component 104. In some embodiments, button 108 can be located on a side of wearable device 100, underneath display 102.

Display 102 according to example embodiments described herein can constitute and/or include any type of electronic display or screen known in the art. For example, in some embodiments, display 102 can constitute and/or include a liquid crystal display (LCD) or organic light emitting diode (OLED) display such as, for instance, a transmissive LCD display or a transmissive OLED display. Display 102 according to example embodiments can be configured to provide brightness, contrast, and/or color saturation features according to display settings that can be maintained by control circuitry and/or other internal components and/or circuitry of wearable device 100. In some embodiments, display 102 can constitute and/or include a touchscreen such as, for instance, a capacitive touchscreen. For example, in these embodiments, display 102 can constitute and/or include a surface capacitive touchscreen or a projective capacitive touch screen that can be configured to respond to contact with electrical charge-holding members or tools, such as a human finger.

In some embodiments, display 102 can be configured to provide (e.g., render) a variety of information such as, for example, the time, the date, body signals (e.g., physiological data of a user wearing wearable device 100), readings based upon user input, and/or other information. In one embodiment, such body signals can include, but are not limited to, heart rate data (e.g., heart beats per minute), motion data (e.g., movement data, accelerometer data), blood pressure data, body temperature data, respiration rate data, blood oxygenation level data, deoxyribonucleic acid (DNA) data, electrodermal activity (EDA) data, stress related data and/or any other body signal that one of ordinary skill in the art would understand that can be measured by a wearable device such as, for instance, wearable device 100. In some embodiments, the readings based upon user input can include, but are not limited to, the number of steps a user has taken, the distance traveled by the user, the sleep schedule of the user, travel routes of the user, elevation climbed by the user, and/or any other metric that one of ordinary skill in the art would understand that can be input by a user into a wearable device such as, for instance, wearable device 100.

In some embodiments, the display 102 can be configured to display a low-power operating domain interface or a high-performance operating domain interface, or to switch between the two. In some implementations, the low-power operating domain interface can be similar, or identical to, the high-performance operating domain interface. For example, both the low-power operating domain interface and the high-performance operating domain interface can display the same interface elements, but the high-performance operating domain interface can utilize a higher brightness parameter value (e.g., making the display more luminous) and can update real-time data elements at a higher frequency than the update frequency of the low-power operating domain interface.

Additionally, or alternatively, in some implementations, the low-power operating domain interface can be different than the high-performance operating domain interface. For example, to minimize power consumption, the low-power operating domain interface can include interface elements that can be fully operated via a low-power processor device of the wearable device 100, such as a time indicator, a weather indicator, a date indicator, etc. Conversely, the high-performance operating domain interface can include a number of real-time data elements that depict real-time data, such as biometric data (e.g., a heartbeat of a user, motion information, etc.), stock quotes, calendar information (e.g., scheduled meetings, etc.), etc.

The low-power operating domain interface can be displayed with the display 102 when the wearable device 100 is operating in a low-power operating domain. The low-power operating domain can be implemented when a user is not interacting with the wearable device 100, or is not predicted to imminently begin interacting with the wearable device 100. As such, the low-power operating domain interface can generally be displayed via the display 102 when the wearable device 100 is not directly observed by the user. In other words, when the user is not actively looking at the wearable device 100, the low-power operating domain interface can be displayed.

In at least one embodiment of the present disclosure, the above-described body signals and/or readings based upon user input can be used to calculate further analytics to provide a user with data such as, for instance, a fitness score, a sleep quality score, a number of calories burned by the user, and/or other data. In some embodiments, wearable device 100 can take in (e.g., capture, collect, receive, measure) outside data irrespective of the user such as, for example: an ambient temperature of an environment surrounding and/or external to wearable device 100; an amount of sun exposure wearable device 100 is subjected to; an atmospheric pressure of the environment surrounding and/or external to wearable device 100; an air quality of the environment surrounding and/or external to wearable device 100; the location of wearable device 100 based on, for instance, a global positioning system (GPS); and/or other outside factors that one of ordinary skill in the art would understand a wearable device such as, for instance, wearable device 100 can take in (e.g., capture, collect, receive, measure).

Attachment component 104 according to example embodiments described herein can be used to attach (e.g., affix, fasten) wearable device 100 to a user of wearable device 100. In some embodiments, attachment component 104 can take the form of, for example, a strap, an elastic band, a rope, and/or any other form of attachment one of ordinary skill in the art would understand can be used to attach a wearable device such as, for instance, wearable device 100 to a user.

Securement component 106 according to example embodiments of the present disclosure can facilitate attachment of attachment component 104 upon a user of wearable device 100. In some embodiments, securement component 106 can include, but is not limited to, a pin and hole locking mechanism (e.g., a buckle), a magnet system, a lock, a clip, and/or any other type of securement that one of ordinary skill would understand can be used to facilitate attachment of a wearable device such as, for instance, wearable device 100 to a user. In one embodiment, wearable device 100 does not include securement component 106. For example, in this or another embodiment, wearable device 100 can be secured to a user with a strap that can be tied around the user's wrist and/or another suitable appendage.

Button 108 according to example embodiments described herein can allow for a user to interact with wearable device 100 and/or allow for the user to provide a form of input into wearable device 100. In the example embodiment depicted in FIGS. 1, 2, and 3, one button 108 is shown on wearable device 100. However, it should be appreciated that wearable device 100 is not so limiting. For example, in some embodiments, wearable device 100 can include any number of buttons that allow a user to further interact with wearable device 100 and/or to provide alternative inputs. In at least one embodiment, wearable device 100 does not include button 108. For instance, as described above, in example embodiments, wearable device 100 can include a screen such as, for example, a touch screen that can receive inputs through (e.g., by way of) the touch of the user. In additional or alternative embodiments, wearable device 100 can include a microphone that can receive inputs through (e.g., by way of) voice commands of a user.

Some implementations of the present disclosure are described in the context of a user intending a particular type of interaction with the wearable device 100 that requires the wearable device 100 to operate in the high-performance operating domain. In some implementations, this particular type of interaction can include interacting with the button 108. Alternatively, in some implementations, interacting with the button 108 is considered to be the particular type of interaction depending on which operations (if any) are performed in response to the button 108 being pressed. For example, if a gaming application is selected and the user interacts with the button 108 (and thus executes the application), the interaction can be considered to be of the particular type of interaction. For another example, if a “sleep” feature is highlighted and the user interacts with the button 108, the user interaction with the button 108 may not be considered to be of the particular type of interaction.

In some embodiments, wearable device 100 can constitute a portable computing device that can be designed so that it can be inserted into a wearable case (e.g., as illustrated in the example embodiments depicted in FIGS. 1, 2, and 3). In some embodiments, wearable device 100 can constitute a portable computing device that can be designed so that it can be inserted into one or more of multiple different wearable cases (e.g., a wristband case, a belt-clip case, a pendant case, a case configured to be attached to a piece of exercise equipment such as a bicycle). Wearable device 100 according to embodiments described herein can be formed into one or more shapes and/or sizes to allow for coupling to (e.g., secured to, worn, borne by) the body or clothing of a user. In some embodiments, wearable device 100 can constitute a portable computing device that can be designed to be worn in limited manners such as, for instance, a computing device that is integrated into a wristband in a non-removable manner and/or can be intended to be worn specifically on a person's wrist (or perhaps ankle).

Irrespective of configuration, wearable device 100 according to example embodiments of the present disclosure can include one or more physiological and/or environmental sensors (e.g., internal physiological sensor(s) 143, external physiological sensor(s) 145, and/or environmental sensor(s) 155) that can be configured to collect physiological and/or environmental data in accordance with various embodiments disclosed herein. In some embodiments, wearable device 100 can be configured to analyze and/or interpret collected physiological and/or environmental data to perform one or more health, wellness, and/or well-being assessments (e.g., physical, mental, emotional, behavioral, and/or sleep quality assessment(s)) of a user (e.g., a wearer) of wearable device 100 according to one or more embodiments described herein. In additional and/or alternative embodiments, wearable device 100 can be configured to communicate with another computing device or server that can perform such one or more health, wellness, and/or well-being assessments (e.g., physical, mental, emotional, behavioral, and/or sleep quality assessment(s)) of a user (e.g., a wearer) of wearable device 100 according to one or more embodiments described herein.

Wearable device 100 in accordance with one or more example embodiments of the present disclosure can include one or more physiological and/or environmental components and/or modules that can be designed to determine one or more physiological and/or environmental metrics associated with a user (e.g., a wearer) of wearable device 100. In at least one embodiment, such physiological and/or environmental component(s) and/or module(s) can constitute and/or include one or more physiological and/or environmental sensors. For instance, although not depicted in the example embodiments illustrated in FIGS. 1, 2, and 3, in some embodiments, wearable device 100 can include one or more physiological and/or environmental sensors such as, for example, an accelerometer, a heart rate sensor (e.g., photoplethysmography (PPG) sensor), an electrodermal activity (EDA) sensor, a body temperature sensor, an environment temperature sensor, and/or another physiological and/or environmental sensor. In these or other embodiments, such physiological and/or environmental sensor(s) can be disposed on, coupled to, and/or otherwise be associated with an underside and/or a backside (e.g., back 134) of wearable device 100.

In some embodiments, the above-described physiological and/or environmental sensor(s) can be disposed on, coupled to, and/or otherwise be associated with wearable device 100 such that the sensor(s) can be in contact with or substantially in contact with human skin when wearable device 100 is worn by a user. For example, in embodiments where wearable device 100 can be worn on a user's wrist, the physiological and/or environmental sensor(s) can be disposed on, coupled to, and/or otherwise be associated with back 134 that can be substantially opposite display 102 and touching an arm of the user. In one embodiment, the above-described physiological and/or environmental sensor(s) can be disposed on, coupled to, and/or otherwise be associated with an interior or skin-side of wearable device 100 (e.g., a side of wearable device 100 that contacts, touches, and/or faces the skin of the user such as, for instance, back 134 and/or bottom 142). In another embodiment, the physiological and/or environmental sensors can be disposed on one or more sides of wearable device 100, including the skin-side (e.g., back 134, bottom 142) and one or more sides (e.g., first side 136, second side 138, top 140, display 102) of wearable device 100 that face and/or are exposed to the ambient environment (e.g., the external environment surrounding wearable device 100).

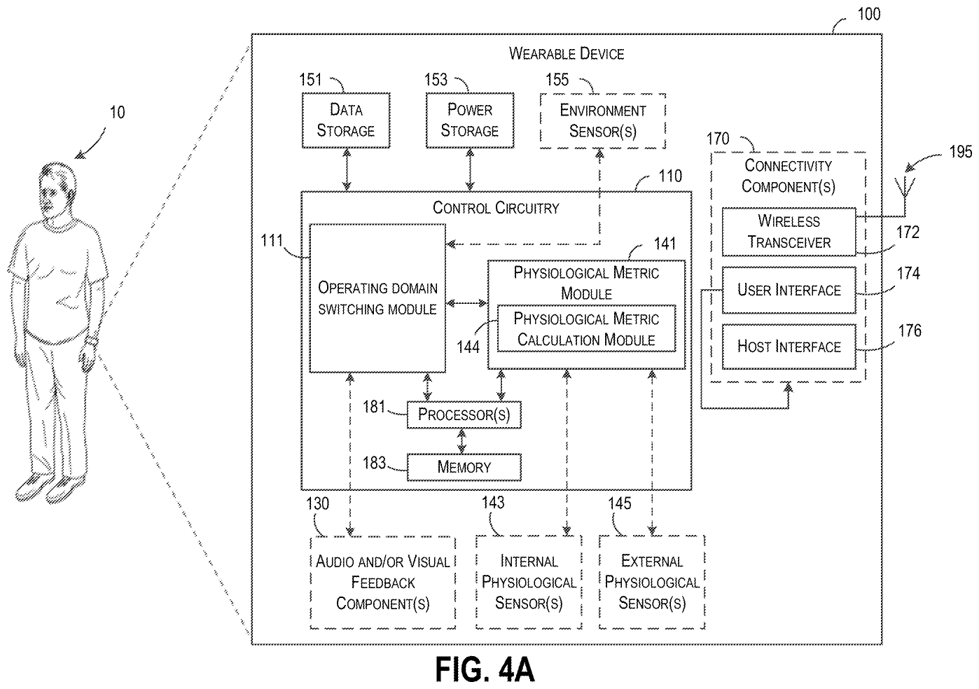

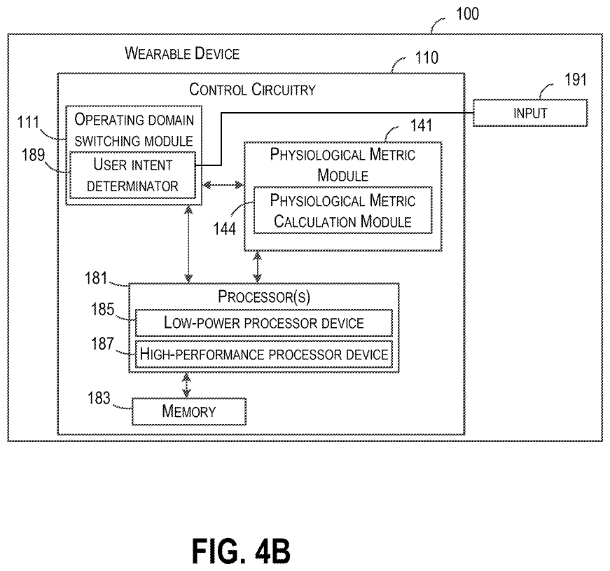

FIG. 4A illustrates a block diagram of the above-described example, non-limiting wearable device 100 according to one or more example embodiments of the present disclosure. That is, for instance, FIG. 4A illustrates a block diagram of one or more internal and/or external components of the above-described example, non-limiting wearable device 100 according to one or more example embodiments of the present disclosure.

As described above with reference to the example embodiments depicted in FIGS. 1, 2, and 3, wearable device 100 can constitute and/or include a wearable computing device such as, for instance, a wearable physiological monitoring device. For example, in the example embodiment depicted in FIG. 4A, wearable device 100 can constitute and/or include a wearable physiological monitoring device that can be worn by a user 10 (also referred to herein as a “wearer” or “wearer 10”) and/or can be configured to gather data regarding activities performed by user 10 and/or data regarding user's 10 physiological state (e.g., temperature). In this or another embodiment, such data can include data representative of the ambient environment around user 10 or user's 10 interaction with the environment. For example, in some embodiments, the data can constitute and/or include motion data regarding user's 10 movements, ambient light, ambient noise, air quality, and/or physiological data obtained by measuring various physiological characteristics of user 10 (e.g., heart rate, respiratory data, body temperature, blood oxygen levels, perspiration levels, movement data).

Although certain embodiments are disclosed herein in the context of wearable physiological monitoring devices, it should be appreciated that the present disclosure is not so limiting. For example, it should be understood that one or more embodiments can by performed and/or implemented using any suitable or desirable type of computing device or combination of computing devices such as, for example, a client computing device, a laptop, a tablet, a wearable computing device (e.g., wearable device 100), a smartphone, and/or another computing device, whether wearable or not.

As illustrated in FIG. 4A, wearable device 100 according to example embodiments of the present disclosure can include one or more audio and/or visual feedback components 130 such as, for instance, electronic touchscreen display units, light-emitting diode (LED) display units, audio speakers, light-emitting diode (LED) lights, buzzers, and/or another type of audio and/or visual feedback module. In certain embodiments, one or more audio and/or visual feedback modules 130 can be located on and/or otherwise associated with a front side of wearable device 100 and/or display 102. For example, in wearable embodiments of wearable device 100, an electronic display such as, for instance, display 102 can be configured to be externally presented to user 10 viewing wearable device 100.

Wearable device 100 according to example embodiments of the present disclosure can include control circuitry 110. Although certain modules and/or components are illustrated as part of control circuitry 110 in the diagram of FIG. 4A, it should be understood that control circuitry 110 associated with wearable device 100 and/or other components or devices in accordance with example embodiments of the present disclosure can include additional components and/or circuitry such as, for instance, one or more additional components of the illustrated components depicted in FIG. 4A. Furthermore, in certain embodiments, one or more of the illustrated components of control circuitry 110 can be omitted and/or different than that shown in FIG. 4A and described in association therewith.

The term “control circuitry” is used herein according to its broad and/ordinary meaning and can include any combination of software and/or hardware elements, devices, and/or features that can be implemented in connection with operation of wearable device 100. Furthermore, the term “control circuitry” can be used substantially interchangeably in certain contexts herein with one or more of the terms “controller,” “integrated circuit,” “IC,” “application-specific integrated circuit,” “ASIC,” “controller chip,” or the like.

Control circuitry 110 according to example embodiments of the present disclosure can constitute and/or include one or more processors, data storage devices, and/or electrical connections. In one embodiment, control circuitry 110 can be implemented on a system on a chip (SoC), however, those skilled in the art will recognize that other hardware and/or firmware implementations are possible.

In one or more embodiments of the present disclosure, control circuitry 110 can constitute and/or include one or more processors 181 that can be configured to execute computer-readable instructions that, when executed, cause wearable device 100 to perform one or more operations. In at least one embodiment, control circuitry 110 can constitute and/or include processor(s) 181 that can be configured to execute operational code (e.g., instructions, processing threads, software) for wearable device 100 such as, for instance, firmware or the like. Processor(s) 181 according to example embodiments described herein can each be a processing device. For instance, in the example embodiment depicted in FIG. 4A, processor(s) 181 can each be a central processing unit (CPU), microprocessor, microcontroller, integrated circuit (e.g., an application-specific integrated circuit (ASIC)), and/or another type of processing device. In this or another example embodiment, processor(s) 181 can be coupled to (e.g., electrically, communicatively, physically, operatively) to one or more components of control circuitry 110 and/or wearable device 100 such that processor(s) 181 can facilitate one or more operations in accordance with one or more example embodiments described herein.

In at least one embodiment of the present disclosure, the above-described computer-readable instructions and/or operational code that can be executed by processor(s) 181 can be stored in one or more data storage devices of wearable device 100. In the example embodiment depicted in FIG. 4A, such computer-readable instructions and/or operational code can be stored in memory 183 of wearable device 100. In this or another example embodiment, memory 183 can be coupled to (e.g., electrically, communicatively, physically, operatively) to one or more components of control circuitry 110 and/or wearable device 100 such that memory 183 can facilitate one or more operations in accordance with one or more example embodiments described herein.

Memory 183 according to example embodiments described herein can store computer-readable and/or computer executable entities (e.g., data, information, applications, models, algorithms) that can be created, modified, accessed, read, retrieved, and/or executed by each of processor(s) 181. In some embodiments, memory 183 can constitute, include, be coupled to (e.g., operatively), and/or otherwise be associated with a computing system and/or media such as, for example, one or more computer-readable media, volatile memory, non-volatile memory, random-access memory (RAM), read only memory (ROM), hard drives, flash drives, and/or other memory devices. In these or other embodiments, such one or more computer-readable media can include, constitute, be coupled to (e.g., operatively), and/or otherwise be associated with one or more non-transitory computer-readable media. Although not depicted in the example embodiment illustrated in FIG. 4A, in some embodiments, memory 183 can include (e.g., store) an operating domain switching module 111, and/or other modules and/or data that can be used to facilitate one or more operations described herein.

Control circuitry 110 according to example embodiments of the present disclosure can constitute and/or include operating domain switching module 111. The operating domain switching module 111 according to example embodiments of the present disclosure can constitute and/or include one or more hardware and/or software components and/or features that can be configured to perform switching, or transitioning, from one operating domain to another in accordance with one or more embodiments described herein. For example, in some embodiments, the operating domain switching module 111 can constitute and/or include one or more hardware and/or software components and/or features that can be configured to switch from a low-power operating domain to a high-performance operating domain.

As described herein, an “operating domain” generally refers to a process by which the wearable device 100 operates while in the particular operating domain. Specifically, an operating domain can indicate particular hardware resources to utilize while operating in the operating domain. For example, while operating in a low-power operating domain, the wearable device 100 may be (at least partially) limited to utilizing a low-power processing device to perform operations. For another example, while operating in a high-performance operating domain, the wearable device 100 may be (at least partially) allowed to utilize a high-performance processing device to perform operations.

Permissions to utilize such hardware resources can be handled in any conventional manner. In some implementations, the wearable device 100 may execute isolated operating systems, kernels, etc. for each processor device (e.g., a low-power operating system executed by the low-power processor device, a high-performance operating system executed by the high-performance processor device, etc. Additionally, or alternatively, in some implementations, the wearable device 100 may schedule certain operations for certain devices using a scheduler or the like. For example, assume that the wearable device 100 switches from a low-power operating domain to a high-performance operating domain. A scheduler of the wearable device 100 may maintain partial or full utilization of the low-power processor device while operating in the high-performance operating domain if optimal.

In one embodiment, operating domain switching module 111 can constitute and/or include one or more of the ML and/or Al models described herein (e.g., a classifier) that can identify such a correlation or absence of correlation between an input received at the wearable device 100 and an intent of the user 10 to perform a particular type of interaction with the wearable device 100 that requires the wearable device 100 to operate in the high-performance operating domain. In one embodiment, wearable device 100 can train such ML and/or Al model(s) as described herein using the above-described annotated physiological dataset. In one embodiment, wearable device 100 can implement (e.g., execute, run) such ML and/or Al model(s) to identify such a correlation or absence of correlation.

In some embodiments, based at least in part on (e.g., in response to) sensing a surface temperature, wearable device 100 can perform one or more operations described herein to facilitate alteration (e.g., improvement) of user's 10 health, wellness, and/or well-being (e.g., physical, mental, emotional, behavioral, and/or sleep quality). For example, in at least one embodiment, wearable device 100 can perform operation(s) that can include, but not limited to: presenting the sensed temperature to user 10 and/or another computing device; providing user 10 and/or another computing device with an explanation of the sensed temperature, which can include a defined activity as described herein, suggesting one or more health improvement recommendations and/or engage another computing device to make such recommendation(s) based at least in part on (e.g., using) the sensed temperature (e.g., recommendation that user 10 seek medical attention, or seek epidemiological testing); implementing one or more wellness promoting features and/or engage another computing device to implement such feature(s) based at least in part on (e.g., using) the correlation or absence of correlation (e.g., vibrating in a particular manner to indicate to a user that they should reduce physical exertion, etc.); and/or another operation according to one or more example embodiments of the present disclosure.

In certain embodiments, physiological metric module 141 and/or physiological metric calculation module 144 can be communicatively coupled with one or more internal physiological sensors 143 that can be embedded and/or integrated in wearable device 100. In certain embodiments, physiological metric module 141 and/or physiological metric calculation module 144 can be optionally in communication with one or more external physiological sensors 145 not embedded and/or integrated in wearable device 100 (e.g., an electrode or sensor integrated in another electronic device). In some embodiments, examples of internal physiological sensors 143 and/or external physiological sensors 145 can constitute and/or include, but are not limited to, one or more sensors that can measure (e.g., capture, collect, receive) physiological data of user 10 such as, for instance, heart rate, blood oxygen level, movement, respiration, perspiration, stress data, and/or other physiological data of user 10.

In the example embodiment depicted in FIG. 4A, wearable device 100 can include one or more data storage components 151 (denoted as “data storage 151” in FIG. 4A). Data storage component(s) 151 according to example embodiments can constitute and/or include any suitable or desirable type of data storage such as, for instance, solid-state memory, which can be volatile or non-volatile. In some embodiments, such solid-state memory of wearable device 100 can constitute and/or include any of a wide variety of technologies such as, for instance, flash integrated circuits, phase change (PC) memory, phase change (PC) random-access memory (RAM), programmable metallization cell RAM (PMC-RAM or PMCm), ovonic unified memory (OUM), resistance RAM (RRAM), NAND memory, NOR memory, EEPROM, ferroelectric memory (FeRAM), MRAM, or other discrete NVM (non-volatile solid-state memory) chips. In some embodiments, data storage component(s) 151 can be used to store system data, such as operating system data and/or system configurations or parameters. In some embodiments, wearable device 100 can include data storage utilized as a buffer and/or cache memory for operational use by control circuitry 110.

Data storage component(s) 151 according to example embodiments can include various sub-modules that can be implemented to facilitate the physiological monitoring and the health, wellness, and/or well-being assessment principles and features disclosed herein (e.g., temperature sensing) in accordance with one or more embodiments. For example, in at least one embodiment, data storage 151 can include one or more sub-modules that can include, but not limited to: an information collection module (e.g., physiological metric module 141, physiological metric calculation module 144) that can manage the collection of physiological and/or environmental data relevant to any health, wellness, and/or well-being assessment described herein (e.g., body temperature sensing); a heart rate determination module that can determine values and/or patterns of one or more types of heart rates of user 10; a condition determination module that can determine a condition that may cause the temperature at the surface of the user 10 (e.g., the user's skin), such as a disease, hyperthermia, hypothermia, exercise, etc.); a presentation module that can manage presentation of information to user 10 that can be associated with any health, wellness, and/or well-being assessment described herein (e.g., body temperature); a feedback management module for collecting and interpreting any input data and/or feedback received from user 10 (e.g., information associated with user's 10 body temperature); and/or another sub-module.

Wearable device 100 according to example embodiments can further include a power storage module 153 (denoted as “power storage 153”), which can constitute and/or include a rechargeable battery, one or more capacitors, or other charge-holding device(s). In some embodiments, the power stored by power storage module 153 can be utilized by control circuitry 110 for operation of wearable device 100, such as for powering display 102. In some embodiments, power storage module 153 can receive power over a host interface of wearable device 100 (e.g., via one or more host interface circuitry and/or components 176 (denoted as “host interface 176” in FIG. 4A)) and/or through other means.

Wearable device 100 according to example embodiments can further include one or more environmental sensors 155. In at least one embodiment, examples of such environmental sensors 155 can include, but are not limited to, sensors that can determine and/or measure, for instance, ambient light, external (non-body) temperature, altitude, device location (e.g., global-positioning system (GPS)), and/or another environmental data.

Wearable device 100 according to example embodiments can further include one or more connectivity components 170, which can include, for example, a wireless transceiver 172. Wireless transceiver 172 according to example embodiments can be communicatively coupled to one or more antenna devices 195, which can be configured to wirelessly transmit and/or receive data and/or power signals to and/or from wearable device 100 using, but not limited to, peer-to-peer, WLAN, and/or cellular communications. For example, wireless transceiver 172 can be utilized to communicate data and/or power between wearable device 100 and an external computing device (not illustrated in FIG. 4A) such as, for instance, an external client computing device (e.g., a smartphone, tablet, computer) and/or an external host system (e.g., a server), which can be configured to interface with wearable device 100. In certain embodiments, wearable device 100 can include one or more host interface circuitry and/or components 176 (denoted as “host interface 176” in FIG. 4A) such as, for instance, wired interface components that can communicatively couple wearable device 100 with the above-described external computing device (e.g., a smartphone, table, computer, server) to receive data and/or power therefrom and/or transmit data thereto.

Connectivity component(s) 170 according to example embodiments can further include one or more user interface components 174 (denoted as “user interface 174” in FIG. 4A) that can be used by wearable device 100 to receive input data from user 10 and/or provide output data to user 10. In some embodiments, user interface component(s) 174 can be coupled to (e.g., operatively, communicatively) and/or otherwise be associated with audio and/or visual feedback component(s) 130. For instance, in these embodiments, display 102 of wearable device 100 can constitute and/or include a touchscreen display that can be configured to provide (e.g., render) output data to user 10 and/or to use audio and/or visual feedback component(s) 130 to receive user input through user contact with the touchscreen display. In some embodiments, user interface component(s) 174 can further constitute and/or include one or more buttons or other input components or features.

Connectivity component(s) 170 according to example embodiments can further include host interface circuitry and/or component(s) 176, which can be, for example, an interface that can be used by wearable device 100 to communicate with the above-described external computing device (e.g., a smartphone, table, computer, server) over a wired or wireless connection. Host interface circuitry and/or component(s) 176 according to example embodiments can utilize and/or otherwise be associated with any suitable or desirable communication protocol and/or physical connector such as, for instance, universal serial bus (USB), micro-USB, Wi-Fi, Bluetooth, FireWire, PCIe, or the like. For wireless connections, host interface circuitry and/or component(s) 176 according to example embodiments can be incorporated with wireless transceiver 172.

Although certain functional modules and components are illustrated and described herein, it should be understood that authentication management functionality in accordance with the present disclosure can be implemented using a number of different approaches. For example, in some embodiments, control circuitry 110 can constitute and/or include one or more processors (e.g., processor(s) 181) that can be controlled by computer-executable instructions that can be stored in a memory (e.g., memory 183, data storage component(s) 151) so as to provide functionality such as is described herein. In other embodiments, such functionality can be provided in the form of one or more specially designed electrical circuits. In some embodiments, such functionality can be provided by one or more processors (e.g., processor(s) 181) that can be controlled by computer-executable instructions that can be stored in a memory (e.g., memory 183, data storage component(s) 151) that can be coupled to (e.g., communicatively, operatively, electrically) one or more specially designed electrical circuits. Various examples of hardware that can be used to implement the concepts outlined herein can include, but are not limited to, application specific integrated circuits (ASICs), field-programmable gate arrays (FPGAs), and general-purpose microprocessors that can be coupled with memory that stores executable instructions for controlling the general-purpose microprocessors.

FIG. 4B illustrates a block diagram of the control circuitry 110 of the above-described example, non-limiting wearable device 100 according to one or more example embodiments of the present disclosure. Specifically, as depicted, the control circuitry 100 includes the processor(s) 181. The processor(s) 181 can include a low-power processor device 185 and a high-performance processor device 187. The low-power processor device 185 can be any type of physical processor device, virtualized processor device, processor core, ASIC, FPGA, etc. designed to perform operations with reduced power consumption. The high-performance processor device 187 can be any type of physical processor device, virtualized processor device, processor core, ASIC, FPGA, etc. designed to perform operations that are computationally expensive. In some implementations, the low-power processor device 185 and the high-performance processor device 187 can be two cores of a multi-core processor. For example, the low-power processor device 185 can be a “smaller” core with while the high-performance processor device 187 can be a “larger” core with a greater number of transistors.

The processor(s) 181 can implement the operating domain switching module 111. The operating domain switching module 111 can determine whether the wearable device 100 is to operate in a low-power operating domain or a high-performance operating domain. Additionally, the operating domain switching module 111 can switch between operating domains such as the low-power operating domain and the high-performance operating domain.

To do so, the operating domain switching module 111 can include a user intent determinator 189. The user intent determinator 189 can determine whether a user intends to perform a particular type of interaction that requires the wearable device 100 to operate in the high-performance operating domain. In other words, the user intent determinator 189 can determine whether a user intends to utilize a feature powered by the high-performance processor device 187 while operating in the high-performance operating mode. The user intent determinator 189 can make this determination based on an input 191.

The input 191 can be, or otherwise include, any type or manner of information obtained by the wearable device 100. In some implementations, the input 191 can include movement data indicative of a movement performed by the user to move the wearable device 100 closer to the user's face. Additionally, or alternatively, in some implementations, the input 191 can include sensor data. For example, the input 191 can include sensor data from a biometric sensor indicating that the user has recently performed strenuous physical activity. Additionally, or alternatively, in some implementations, the input 191 can include temporal data. For example, the input 191 can indicate that a meeting is scheduled to begin imminently. Additionally, or alternatively, in some implementations, the input 191 can include notification information. For example, the input 191 can be a notification or other message received from an application executed by the wearable device or from a server associated with such an application. For another example, the input 191 can be an operating system level message or indication.

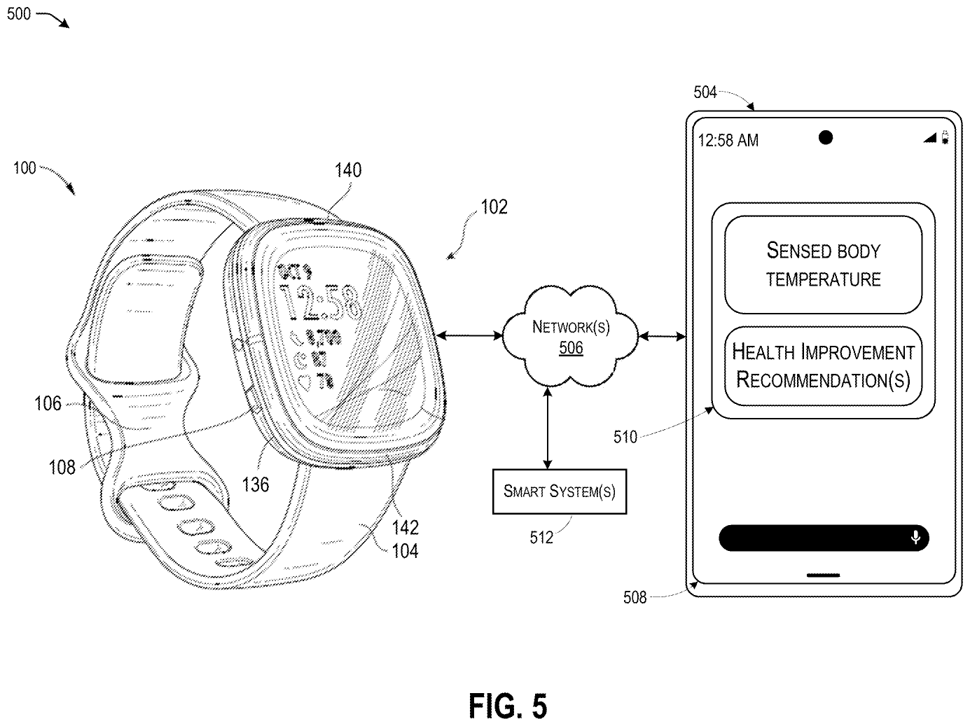

FIG. 5 illustrates a diagram of an example, non-limiting user assessment management system 500 according to one or more example embodiments of the present disclosure. User assessment management system 500 depicted in FIG. 5 illustrates an example, non-limiting networked relationship between wearable device 100, an external computing device 504, and/or one or more smart systems 512 in accordance with one or more embodiments. In particular, it should be noted that the user assessment management system 500, and some, or all, of the components or sub-systems of the user assessment management system 500, are illustrated to provide an example of operations that require the high-performance operating domain.

With reference to the example embodiment described above and depicted in FIG. 4A, wearable device 100 according to example embodiments of the present disclosure can perform one or more health, wellness, and/or well-being assessments (e.g., physical, mental, emotional, behavioral, and/or sleep quality assessment(s)) of user 10 and/or perform operation(s) to facilitate alteration (e.g., improvement) of user's 10 health, wellness, and/or well-being based on such assessment(s). As such, in certain embodiments described in the present disclosure, wearable device 100 can be capable of and/or configured to collect physiological sensor readings of user 10 and/or perform such assessment(s) and/or operation(s) using such readings.

However, in additional and/or alternative embodiments, wearable device 100 and/or another electronic and/or computing device that can be used to detect physiological information of user 10, can be in communication with external computing device 504. In these and/or other embodiments, external computing device 504 can be configured to use such physiological information of user 10 to perform such one or more health, wellness, and/or well-being assessments (e.g., body temperature sensing) of user 10 according to one or more embodiments described herein. In these and/or other embodiments, based at least in part on (e.g., in response to) performing such assessment(s), external computing device 504 can perform one or more operations described herein to facilitate alteration (e.g., improvement) of user's 10 health, wellness, and/or well-being (e.g., physical, mental, emotional, behavioral, and/or sleep quality).

Wearable device 100 according to example embodiments can be configured to collect one or more types of physiological and/or environmental data using embedded sensors and/or external devices, as described throughout the present disclosure, and communicate or relay such information over one or more networks 506 to other devices. This includes, in some embodiments, relaying information to devices capable of serving as Internet-accessible data sources, thus permitting the collected data to be viewed, for example, using a web browser or network-based application at, for instance, external computing device 504. For example, while user 10 is wearing wearable device 100, wearable device 100 can capture, calculate, and/or store environment data and/or user's 10 physiological data (e.g., heart rate, motion data, temperature, respiration, perspiration, EDA, stress data) using one or more environmental and/or physiological sensors. Wearable device 100 according to example embodiments can then transmit data representative of such environment data and/or user's 10 physiological data over network(s) 506 to an account on a web service, computer, mobile phone, and/or health station where the data can be stored, processed, and visualized by user 10 and/or another entity (e.g., a health care professional).

While wearable device 100 is shown in example embodiments of the present disclosure to have a display, it should be understood that, in some embodiments, wearable device 100 does not have any type of display unit. In some embodiments, wearable device 100 can have audio and/or visual feedback components such as, for instance, light-emitting diodes (LEDs), buzzers, speakers, and/or a display with limited functionality. Wearable device 100 according to example embodiments can be configured to be attached to user's 10 body or clothing. For example, in these or other embodiments, wearable device 100 can be configured as a wrist bracelet, watch, ring, electrode, finger-clip, toe-clip, chest-strap, ankle strap, and/or a device placed in a pocket. In additional or alternative embodiments, wearable device 100 can be embedded in something in contact with user 10 such as, for instance, clothing, a mat that can be positioned under user 10, a blanket, a pillow, and/or another accessory.

In one or more embodiments of the present disclosure, the communication between wearable device 100 and external computing device 504 can be facilitated by network(s) 506. In some embodiments, network(s) 506 can constitute and/or include, for instance, one or more of an ad hoc network, a peer-to-peer communication link, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, and/or any other type of network. In some embodiments, the communication between wearable device 100 and external computing device 504 can also be performed through a direct wired connection. In these or other embodiments, this direct-wired connection can be associated with any suitable or desirable communication protocol and/or physical connector such as, for instance, universal serial bus (USB), micro-USB, Wi-Fi, Bluetooth, FireWire, PCIe, or the like.

In example embodiments of the present disclosure, a variety of computing devices can be in communication with wearable device 100 to facilitate user's 10 health, wellness, and/or well-being assessment and/or alteration (e.g., improvement). Although external computing device 504 is depicted as a smartphone in the example embodiment illustrated in FIG. 5, it should be understood that the present disclosure is not so limiting. For instance, external computing device 504 according to example embodiments can constitute and/or include, for example, a smartphone with a display 508 as depicted in FIG. 5, a personal digital assistant (PDA), a mobile phone, a tablet, a personal computer, a laptop computer, a smart television, a video game console, a server, and/or another computing device that can be external to wearable device 100.

The networked relationship depicted in the example embodiment illustrated in FIG. 5 demonstrates how, in some embodiments, external computing device 504 can be implemented to perform one or more health, wellness, and/or well-being assessments (e.g., a body temperature assessment) of user 10 and/or perform operation(s) to facilitate alteration (e.g., improvement) of user's 10 health, wellness, and/or well-being based on such assessment(s). For example, in one embodiment, user 10 can wear wearable device 100 that can be equipped as a bracelet with one or more physiological sensors but without a display. In this and/or another embodiment, while user 10 is wearing wearable device 100, wearable device 100 can capture, calculate, and/or store environment data and/or user's 10 physiological data (e.g., temperature) using the physiological sensors. Wearable device 100 according to example embodiments can then transmit data representative of such environment data and/or user's 10 physiological data over network(s) 506 to an account on a web service, computer, mobile phone, and/or health station where the data can be stored, processed, and visualized by user 10 and/or another entity (e.g., a health care professional). In some embodiments, wearable device 100 can periodically or continuously transmit such information to external computing device 504 over network(s) 506.

In additional and/or alternative embodiments, wearable device 100 can store the above-described collected physiological and/or environmental data and transmit this data to external computing device 504 in response to a trigger event such as, for instance, detection of an abnormal surface temperature of the skin of the user 10 (e.g., above or below a threshold range of standard human temperatures) after a period performing the defined activity. In some embodiments, wearable device 100 can transmit such data to external computing device 504 in response to detecting that a command has been performed by external computing device 504 such as, for instance, manual or automatic execution of an instruction to synchronize collected physiological and/or environmental data and perform one or more health, wellness, and/or well-being assessments (e.g., body temperature assessment) of user 10 as described herein.

In some embodiments, external computing device 504 can present (e.g., provide, render) a possible cause of the body temperature of user 10. For instance, in these or other embodiments, external computing device 504 can generate an intelligent notification 510 that can include such body temperature and/or one or more health improvement recommendations (e.g., a suggestion to reduce physical activity, a suggestion to see a healthcare provider, etc.) that, if and/or when implemented by user 10, can facilitate alteration (e.g., improvement) of user's 10 health, wellness, and/or well-being (e.g., body temperature). In the example embodiment depicted in FIG. 5, external computing device 504 can render intelligent notification 510 having such body temperature and the health improvement recommendation(s) on display 508 such that user 10 and/or another entity (e.g., health care professional, mental health care professional, sleep therapy provider, doctor, caregiver) can view such information.

Although not illustrated in the example embodiment depicted in FIG. 5, in some embodiments, wearable device 100 can: sense a body temperature of the user 10; determine one or more health improvement recommendations based on (e.g., in response to) sensing the body temperature; generate intelligent notification 510 such that it includes the body temperature and the health improvement recommendation(s); and render this information on display 102 of wearable device 100.

In one embodiment of the present disclosure, wearable device 100 and/or external computing device 504 can implement (e.g., initiate, run, operate) one or more wellness promoting features that can be included with wearable device 100 and/or external computing device 504 such as, for instance, a wellness promoting audio feature (e.g., by playing a sound that alerts the user to the occurrence of an abnormal body temperature), and/or another wellness promoting feature of wearable device 100 and/or external computing device 504.

In another embodiment of the present disclosure, wearable device 100 and/or external computing device 504 can facilitate implementation of one or more wellness promoting features of another computing device such as, for instance, a computing device of one or more smart systems 512. In this or another embodiment, smart system(s) 512 can constitute and/or include, but are not limited to, an audio system (e.g., a home audio system), a lighting system (e.g., a home lighting system), an HVAC system (e.g., a home HVAC system), an exercise system (e.g., an exercise machine), and/or another system that can be included in, coupled to, and/or operated by a computing device other than wearable device 100 and/or external computing device 504. For instance, in some embodiments, smart system(s) 512 can constitute and/or include a smart audio system, a smart lighting system, a smart HVAC system, and/or a smart exercise system (e.g., a smart exercise machine). In these or other embodiments, wearable device 100 and/or external computing device 504 can facilitate implementation of one or more wellness promoting features of smart system(s) 512 such as, for instance: a wellness promoting audio feature of a smart audio system; a wellness promoting lighting feature of a smart lighting system; a wellness promoting ambient temperature feature of a smart HVAC system; a wellness promoting exercise feature (e.g., a certain exercise mode or setting) of a smart exercise system; and/or another wellness promoting feature of smart system(s) 512.

In some embodiments described herein, wearable device 100 and/or external computing device 504 can send instructions to smart system(s) 512 that, when executed by such system(s) (e.g., via one or more processors), can cause the system(s) to perform operations to implement one or more wellness promoting features of such system(s). In one embodiment, wearable device 100 and/or external computing device 504 can send instructions to a smart audio system that, when executed by such a system (e.g., via one or more processors), can cause it to inform the user 10 that an abnormal body temperature has been detected. In another embodiment, wearable device 100 and/or external computing device 504 can send instructions to a smart HVAC system that, when executed by such a system (e.g., via one or more processors), can cause it to output air at a certain wellness promoting temperature (e.g., a certain temperature that can be defined by user 10). In one embodiment of the present disclosure, wearable device 100 and/or external computing device 504 can send instructions to a smart exercise system that, when executed by such a system (e.g., via one or more processors), can cause it to operate in a certain mode or setting and/or to provide a recommendation to the user to select such a mode or setting.

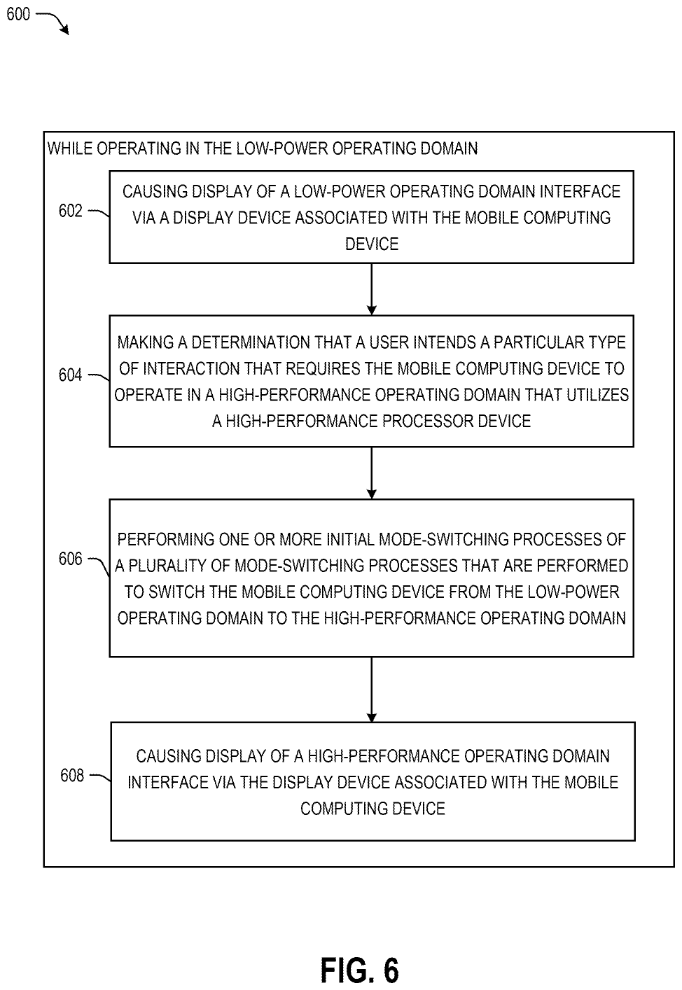

FIG. 6 depicts a flow chart diagram of an example method 600 to perform according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, while operating in a low-power operating domain, a computing device (e.g., computing device, a wearable computing device, etc.) can cause, with a low-power processor device, display of a low-power operating domain interface via a display device associated with the computing device.

At 604, while operating in a low-power operating domain, the computing device can make, with the low-power processor device, a determination that a user of the computing device intends a particular type of interaction with the computing device. The particular type of interaction can require that the computing device operate in a high-performance operating domain that utilizes a high-performance processor device of the plurality of processor devices.

In some implementations, making the determination that the user of the mobile computing device intends the particular type of interaction with the mobile computing device comprises can include determining, with the low-power processor device, that the mobile computing device is located at a particular location.

Additionally, or alternatively, in some implementations, making the determination that the user of the mobile computing device intends the particular type of interaction with the mobile computing device can include receiving, with the low-power processor device, an input indicating that the user intends the particular type of interaction with the mobile computing device. In some implementations, the input can include motion data from an IMU of the mobile computing device, temporal data indicative of occurrence of a particular time, biometric data from one or more biometric sensors of the mobile computing device, data received from an application executed by the mobile computing device, data received via a wireless network connection of the mobile computing device, and/or communication data associated with the user of the mobile computing device. In some implementations, the input includes the motion data, and the motion data is indicative of a movement performed by the user to move the mobile computing device closer to a face of the user.

At 606, while operating in a low-power operating domain, the computing device can, responsive to the determination, perform, with the low-power processor device, one or more initial mode-switching processes of a plurality of mode-switching processes that are performed to switch the computing device from the low-power operating domain to the high-performance operating domain.

In some implementations, performing the one or more initial mode switching processes can include adjusting, with the low-power processor device, a value of an update parameter from the first update frequency to the second update frequency, wherein the update parameter is associated with the real-time data element.

In some implementations, the real-time data is obtained from a sensor device of the computing device, and performing the one or more initial mode switching processes can include increasing, with the low-power processor device, a value of a data polling parameter associated with the sensor device of the mobile computing device, wherein the second update frequency comprises the value of the data polling parameter. For example, the real-time data can include biometric data obtained via a biometric sensor of the mobile computing device, temporal data obtained via a temporal sensor of the computing device, movement data obtained via an Inertial Measurement Unit (IMU) of the computing device, data obtained via a wireless network connection of the computing device, etc.

In some implementations, performing the one or more initial mode switching processes can include increasing, with the low-power processor device, a value of a brightness parameter associated with a display brightness of the display device associated with the mobile computing device.

In some implementations, performing the one or more initial mode switching processes can include increasing, with the low-power processor device, a value of an accuracy parameter associated with an accuracy of an input device of the mobile computing device. The input device can include a touch input device, a radial dial input device, an audio capture device, a video capture device, or a button device.

In some implementations, performing the one or more initial mode-switching processes can include activating, with the low-power processor device, a keyword detection process for detecting a spoken utterance of a keyword by the user of the mobile computing device. The keyword can correspond to a virtual assistant service.

At 608, while operating in a low-power operating domain, the computing device can, responsive to the determination, cause, with the low-power processor device, display of a high-performance operating domain interface via the display device associated with the computing device.

In some implementations, both the low-power operating domain interface and the high-performance operating domain interface includes a real-time data element that depicts real-time data (e.g., biometric data, stock quotes or financial information, real-time notifications, application outputs, movement information, communication data, etc.).

In some implementations, causing display of the low-power operating domain interface can include updating, with the low-power processor device, the real-time data depicted by the real-time data element of the low-power operating domain interface at a first update frequency. Causing display of the high-performance operating domain interface can include updating, with the low-power processor device, the real-time data depicted by the real-time data element of the high-performance operating domain interface at a second update frequency higher than the first update frequency.

In some implementations, the computing device can receive, with the low-power processor device, a second input indicative of occurrence of the particular type of interaction between the user and the computing device. Responsive to receiving the second input, the computing device can switch from the low-power operating domain to the high-performance operating domain.

In some implementations, switching from the low-power operating domain to the high-performance operating domain can include performing each of the plurality of mode-switching processes other than the one or more initial mode-switching processes.

In some implementations, the computing device can perform, with the high-performance processor device, one or more operations associated with the particular type of interaction between the user and the computing device. The computing device can make, with the high-performance processor device, a determination that the user has ceased the particular type of interaction between the user and the computing device. Responsive to the determination, switching, by the computing device, from the high-performance operating domain to the low-power operating domain.

In some implementations, the computing device can make a determination that the user of the computing device no longer intends the particular type of interaction with the computing device that requires the computing device to operate in the high-performance operating domain. Responsive to the determination, the mobile computing device can cause, with the low-power processor device, display of the low-power operating domain interface via the display device associated with the mobile computing device.

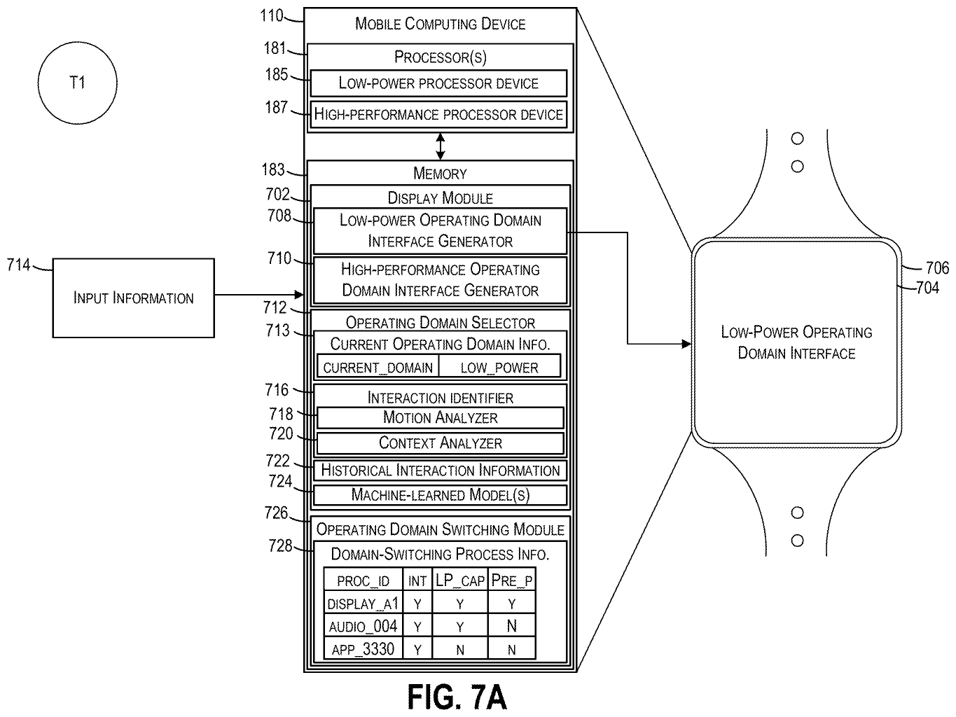

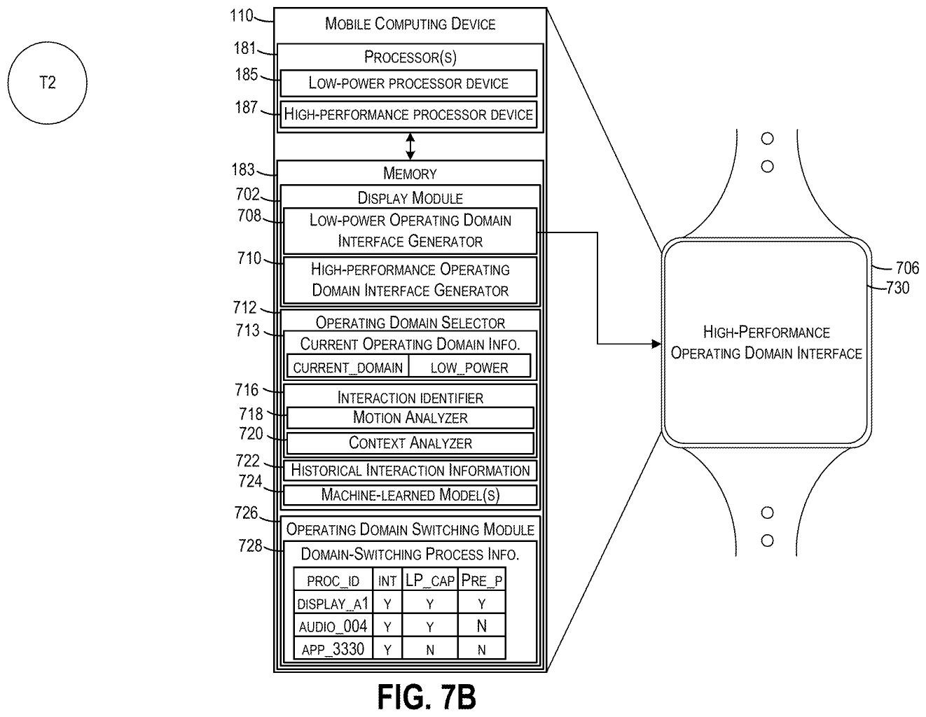

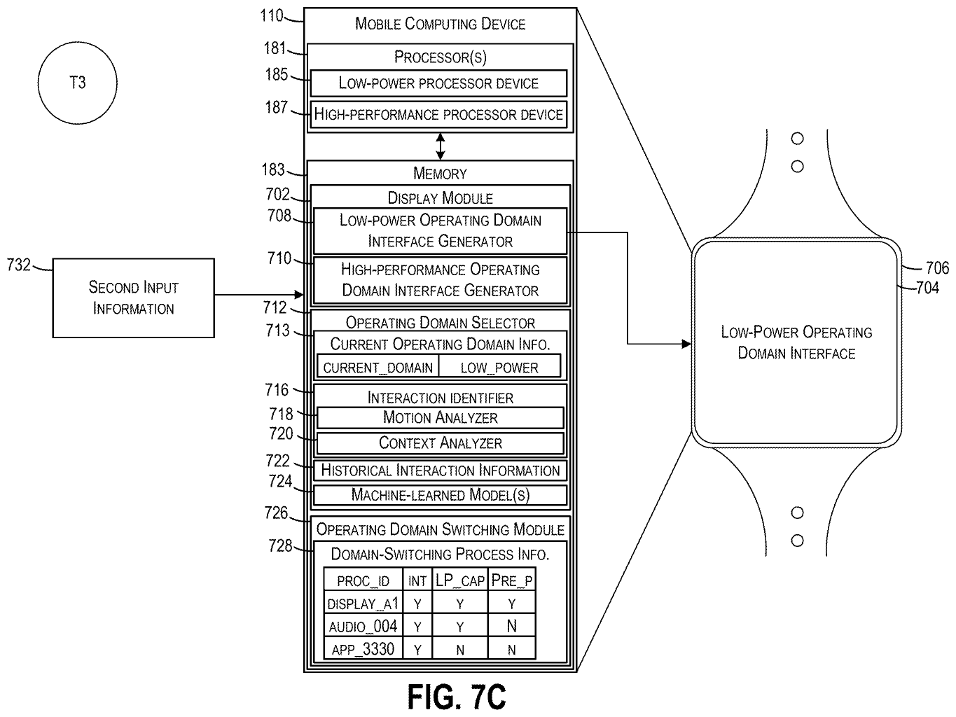

FIGS. 7A-7C are data flow diagrams for reducing perceivable operating domain switching latency by simulating a transition between operating domains for a mobile computing device at times T1-T3 according to some implementations of the present disclosure. FIG. 7A is discussed in conjunction with FIGS. 4A and 4B. More specifically, the mobile computing device 110 can include the processor(s) 181 and the memory 183 as described with regards to FIGS. 4A/4B. The memory 183 can include a display module 702. The display module 702 can generate, and otherwise manage, an interface 704 for display at a display device 706 of the mobile computing device 110.

The display module 702 can generate different interfaces 704 for display at the display device 706. For example, the display module 702 can include a low-power operating domain interface generator 708. The low-power operating domain interface generator 708 can generate a low-power operating domain interface displayed as the interface 704. For another example, the display module 702 can include a high-performance operating domain interface generator 710. The high-performance operating domain interface generator 710 can generate a high-performance operating domain interface displayed as the interface 704. To follow the depicted example, the interface 704 can be a low-power operating domain interface 704.

At the time T1, the display module 702 can utilize the low-power operating domain interface generator 708 to generate the low-power operating domain interface 704 based on the operating domain in which the mobile computing device 110 is operating. More specifically, the memory 183 can include an operating domain selector 712. The operating domain selector 712 can include current operating domain information 713. At the time T1, the current operating domain information 713 can indicate that the mobile computing device 110 is operating in the low-power operating domain.

In the low-power operating domain, the mobile computing device 110 can primarily utilize the low-power processor device 185 to execute various operations. As described with regards to FIGS. 4A/4B, the low-power processor device 185 can be one or more processor device(s) configured to perform operations that are relatively computationally inexpensive in an energy-efficient manner. Conversely, the high-performance processor device 187 can be one or more processor device(s) configured to perform operations that can be computationally expensive. It should be noted that, in some implementations, processor devices other than the low-power processor device 185 can be utilized in the low-power operating domain (and similar with regards to the high-performance processor device 187). For example, an ASIC processor device that performs a particular audio encoding process may be utilized regardless of the operating domain selected by the operating domain selector 712.

The operating domain selector 712 can select an operating domain based on input information 714 received by the mobile computing device 110. The input information 714 can describe a user input (e.g., movement, selection of an input device of the mobile computing device 110, information received by the mobile computing device 110 from another device, etc. For example, if the mobile computing device 110 is a smartwatch, the input information 714 can include IMU data indicative of a motion of the user's arm. For another example, the input information 714 can be geolocation data indicating that the mobile computing device 110 has entered a particular area. For yet another example, the input information 714 can be textual content received from another mobile computing device.

The input information 714 can be analyzed by an interaction identifier 716 of the operating domain selector 712. The interaction identifier 716 can make a determination whether the input information 714 indicates that the user intends to perform a particular type of interaction that requires the mobile computing device to operate in the high-performance operating domain. A “particular type of interaction that requires the mobile computing device to operate in the high-performance operating domain” generally refers to an interaction including operations that cannot be performed using the low-power processor device 185, thus necessitating a switch to the high-performance operating domain to enable utilization of the high-performance processor device 187 to perform the operations. Such interactions can include interactions with input devices of the mobile computing device 110, selecting an application via the interface 704, activating a certain sensor(s) of the mobile computing device 110, etc.

To do so, the interaction identifier 716 can include a motion analyzer 718. If the input information 714 includes motion information, the motion analyzer 718 can determine whether the user intends to perform the particular type of interaction. For example, if the motion information indicates that the user is passively swinging their arm while walking, the motion analyzer 718 can determine that the user does not intend to perform the particular type of interaction. For another example, if the motion information indicates that the user is actively moving the mobile computing device 110 towards their face, the motion analyzer 718 can determine that the user does intend to perform the particular type of interaction.

The interaction identifier 716 can also include a context analyzer 720. The context analyzer 720 can analyze the input information 714 and/or contextual information (not illustrated) to determine whether the user intends to perform the particular type of interaction. For example, the context analyzer 720 may analyze contextual information indicating that the user is driving, and is thus less likely to perform the particular type of interaction. For another example, the context analyzer 720 may analyze contextual information indicating that the user has just finished exercising, and is thus more likely to perform the particular type of interaction.

The operating domain selector 712 can include historical interaction information 722. The historical interaction information 722 can describe input information received previously. The historical interaction information 722 can also describe interactions identified by the interaction identifier 716 and an indication of whether the identified interaction occurred. In other words, the historical interaction information 722 can store information indicating an “accuracy” of the interaction identifier.

In some implementations, the interaction identifier 716 can leverage machine-learned model(s) 724. The machine-learned model(s) 724 can be model(s) trained to process the input information 714 to generate an output that identifies an interaction the user intends to perform. In some implementations, the machine-learned model(s) 724 can be trained based at least in part on the historical interaction information 722.

The memory 183 can include an operating domain switching module 726. The operating domain switching module 726 can switch between operating domains for the mobile computing device 110. To do so, the operating domain switching module 726 can switch between the operating modes based on the determination made by the interaction identifier 716. More specifically, if the interaction identifier 716 make a determination that the input information 714 indicates the user intends to perform the particular type of interaction that requires the mobile computing device to operate in the high-performance operating domain, the operating domain switching module 726 can switch from the low-power operating domain to the high-performance operating domain.

The operating domain switching module 726 can perform a number of different processes to switch operating domains. The operating domain switching module 726 can include domain switching process information 728 that indicates the processes performed by the operating domain switching module 726 to switch operating domains. The domain switching process information 728 can also indicate whether certain processes can be performed using the low-power processor device 185, and/or whether a process is to be performed pre-emptively to reduce latency. To follow the depicted example, the domain switching process information 728 can indicate that the process “display_a1” (e.g., a display activation process) is a process that is performed to switch to the high-performance operating domain (i.e., the “interactive” operating domain) (e.g., “int:y”). The domain switching process information 728 can further indicate that the process “display_a1” can be performed using the low-power processor device 185 (e.g., “lp_cap:y”). The domain switching process information 728 can further indicate that the process “display_a1” is to be performed pre-emptively to reduce perceivable switching latency (“pre_p:y”).

Turning to FIG. 7B, FIG. 7B depicts the mobile computing device 110 at a time T2 subsequent to the time T1 according to some implementations of the present disclosure. Specifically, assume that the operating domain selector 712 of the mobile computing device 110 determines to switch from the low-power operating domain to the high-performance operating domain based on the input information 714. In response, at T2, the display module 702 can generate a high-performance operating domain interface 730. The display module 702 can replace display of the low-power operating domain interface 704 with the high-performance operating domain interface 730.

However, the operating domain switching module 726 can refrain from switching operating domains entirely while replacing display of the low-power operating domain interface 704 with the high-performance operating domain interface 730. Specifically, while operating in the low-power operating domain, the mobile computing device 110 can “simulate” a switch to the high-performance operating domain by utilizing the low-power processor device 185 to replace display of the low-power operating domain interface 704 with the high-performance operating domain interface 730. In other words, although a user viewing the display device 706 would perceive a switch to the high-performance operating domain due to the replacement of the low-power operating domain interface 704 with the high-performance operating domain interface 730, such a switch has not yet occurred. In this manner, the mobile computing device 110 can substantially reduce energy expenditure and thus substantially increase battery life for the mobile computing device 110.

The operating domain switching module 726 can “simulate” the switching between operating domains by pre-emptively performing some of the domain switching processes described by the domain-switching process information 728. For example, assume that the “display_a1” process described by the domain-switching process information 728 is performed by the high-performance operating domain interface generator 710 to generate the high-performance operating domain interface 730. As indicated by the domain-switching process information 728, the “display_a1” process can be performed using the low-power processor device 185 (e.g., “lp_cap: y”). Thus, the process can be performed to simulate switching to the high-performance operating domain without fully switching to the high-performance operating domain.

It should be noted that operating domains described herein are described primarily within the context of two domains: the low-power operating domain and the high-performance operating domain. However, implementations described herein are not limited to these two operating domains. Rather, a variety of operating domains can be switched to and from using the operating domain switching module 726 to optimally perform in a variety of different use-cases. In particular, some, or all, of the operations described herein to simulate operating domain switching can be performed while operating in an “intermediate” operating domain configured as a “middle ground” between the low-power operating domain and the high-performance operating domain. This intermediate operating domain may leverage the low-power processor device 185, the high-performance processor device 187, and/or any other processor device(s) 181 to perform the operations described herein. For example, while operating in the intermediate operating domain, the mobile computing device 110 may primarily operate utilizing the low-power processor device 185 while intermittently scheduling certain operations or processes for the high-performance processor device 187. In this manner, the mobile computing device 110 is provided additional flexibility to pre-emptively perform domain switching processes while still preserving substantial energy expenditure reductions.

Turning to FIG. 7C, FIG. 7C depicts the mobile computing device 110 at a time T3 subsequent to the time T1 and concurrent with or subsequent to T2 according to some implementations of the present disclosure. Specifically, the mobile computing device 110 can receive second input information 732. The second input information 732 can be processed by the interaction identifier 716. Assume that the interaction identifier 716 determines that, based on the second input information 732, the user no longer intends to perform the particular type of interaction. For example, if the input information 704 indicated that the user had raised their arm to their face, the second input information 732 may indicate that the user moved their arm back to their side without interacting with the mobile computing device 110.

Based on the determination of the interaction identifier 716, the operating domain selector 712 can select the low-power operating domain. In response, the operating domain switching module 726 can perform domain-switching processes that reverse any operations performed pre-emptively to switch to the high-performance operating domain.

Thus, a user of the mobile computing device 110 can perceive the mobile computing device 110 switching operating modes without any actual operating mode switch occurring. In this manner, implementations of the present disclosure eliminate a substantial cause of energy expenditure.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method performed by a mobile computing device comprising a plurality of processor devices, the method comprising:
while operating in a low-power operating domain that utilizes a low-power processor device of the plurality of processor devices:
causing, by the mobile computing device with the low-power processor device, display of a low-power operating domain interface via a display device associated with the mobile computing device;
making, by the mobile computing device with the low-power processor device, a determination that a user of the mobile computing device intends a particular type of interaction with the mobile computing device that requires the mobile computing device to operate in a high-performance operating domain that utilizes a high-performance processor device of the plurality of processor devices;
responsive to the determination, performing, by the mobile computing device with the low-power processor device, one or more initial domain-switching processes of a plurality of domain-switching processes that are performed to switch the mobile computing device from the low-power operating domain to the high-performance operating domain; and
responsive to the determination, causing, by the mobile computing device with the low-power processor device, display of a high-performance operating domain interface via the display device associated with the mobile computing device.

2. The computer-implemented method of claim 1, wherein the method further comprises:
receiving, by the mobile computing device with the low-power processor device, a second input indicative of occurrence of the particular type of interaction between the user and the mobile computing device; and
responsive to receiving the second input, switching, by the mobile computing device, from the low-power operating domain to the high-performance operating domain.

3. The computer-implemented method of claim 2, wherein switching from the low-power operating domain to the high-performance operating domain comprises:
performing, by the mobile computing device, each of the plurality of domain-switching processes other than the one or more initial domain-switching processes.

4. The computer-implemented method of claim 3, wherein the method further comprises:
performing, by the mobile computing device with the high-performance processor device, one or more operations associated with the particular type of interaction between the user and the mobile computing device;
making, by the mobile computing device with the high-performance processor device, a determination that the user has ceased the particular type of interaction between the user and the mobile computing device; and
responsive to the determination, switching, by the mobile computing device, from the high-performance operating domain to the low-power operating domain.

5. The computer-implemented method of claim 1, wherein the method further comprises:
making, by the mobile computing device, a determination that the user of the mobile computing device no longer intends the particular type of interaction with the mobile computing device that requires the mobile computing device to operate in the high-performance operating domain; and
responsive to the determination, causing, by the mobile computing device with the low-power processor device, display of the low-power operating domain interface via the display device associated with the mobile computing device.

6. The computer-implemented method of claim 1, wherein both the low-power operating domain interface and the high-performance operating domain interface comprises a real-time data element that depicts real-time data.

7. The computer-implemented method of claim 6, wherein causing display of the low-power operating domain interface comprises:
updating, by the mobile computing device with the low-power processor device, the real-time data depicted by the real-time data element of the low-power operating domain interface at a first update frequency; and
wherein causing display of the high-performance operating domain interface comprises:
updating, by the mobile computing device with the low-power processor device, the real-time data depicted by the real-time data element of the high-performance operating domain interface at a second update frequency higher than the first update frequency.

8. The computer-implemented method of claim 7, wherein performing the one or more initial mode switching processes comprises:
adjusting, by the mobile computing device with the low-power processor device, a value of an update parameter from the first update frequency to the second update frequency, wherein the update parameter is associated with the real-time data element.

9. The computer-implemented method of claim 7, wherein the real-time data is obtained from a sensor device of the mobile computing device; and
wherein performing the one or more initial mode switching processes comprises:
increasing, by the mobile computing device with the low-power processor device, a value of a data polling parameter associated with the sensor device of the mobile computing device, wherein the second update frequency comprises the value of the data polling parameter.

10. The computer-implemented method of claim 7, wherein the real-time data comprises:
biometric data obtained via a biometric sensor of the mobile computing device;
temporal data obtained via a temporal sensor of the mobile computing device;
movement data obtained via an Inertial Measurement Unit (IMU) of the mobile computing device; or
data obtained via a wireless network connection of the mobile computing device.

11. The computer-implemented method of claim 1, wherein performing the one or more initial domain-switching processes comprises:
increasing, by the mobile computing device with the low-power processor device, a value of a brightness parameter associated with a display brightness of the display device associated with the mobile computing device.

12. The computer-implemented method of claim 1, wherein performing the one or more initial domain-switching processes comprises:
increasing, by the mobile computing device with the low-power processor device, a value of an accuracy parameter associated with an accuracy of an input device of the mobile computing device, and wherein the input device comprises:
a touch input device;
a radial dial input device;
an audio capture device;
a video capture device; or
a button device.

13. The computer-implemented method of claim 1, wherein performing the one or more initial domain-switching processes comprises:
activating, by the mobile computing device with the low-power processor device, a keyword detection process for detecting a spoken utterance of a keyword by the user of the mobile computing device, wherein the keyword corresponds to a virtual assistant service.

14. The computer-implemented method of claim 1, wherein making the determination that the user of the mobile computing device intends the particular type of interaction with the mobile computing device comprises:
determining, by the mobile computing device with the low-power processor device, that the mobile computing device is located at a particular location.

15. The computer-implemented method of claim 1, wherein making the determination that the user of the mobile computing device intends the particular type of interaction with the mobile computing device comprises:
receiving, by the mobile computing device with the low-power processor device, an input indicating that the user intends the particular type of interaction with the mobile computing device.

16. The computer-implemented method of claim 15, wherein the input comprises one or more of:
motion data from an IMU of the mobile computing device;
temporal data indicative of occurrence of a particular time;
biometric data from one or more biometric sensors of the mobile computing device;
data received from an application executed by the mobile computing device;
data received via a wireless network connection of the mobile computing device; or
communication data associated with the user of the mobile computing device.

17. The computer-implemented method of claim 16, wherein the input comprises the motion data, and wherein the motion data is indicative of a movement performed by the user to move the mobile computing device closer to a face of the user.

18. A computing device, comprising:
a plurality of processor devices comprising a high-performance processor device and a low-power processor device, wherein the high-performance processor device is utilized when the computing device is operating in a high-performance operating domain, and wherein the low-power processor device is utilized when the computing device is operating in a low-power operating domain;
one or more computer-readable media that collectively store instructions that, when executed by one or more of the plurality of processor devices, cause the computing device to perform operations, the operations comprising:
while operating in the low-power operating domain:
causing, with the low-power processor device, display of a low-power operating domain interface via a display device associated with the computing device; and
detecting, with the low-power processor device, occurrence of an intermediate operating domain switch condition;
responsive to detecting the occurrence of the intermediate operating domain switch condition, switching to an intermediate operating domain, wherein switching to the intermediate operating domain comprises:
performing one or more initial domain-switching processes of a plurality of domain-switching processes that are performed to switch the mobile computing device to the high-performance operating domain; and
causing display of a high-performance operating domain interface via the display device associated with the mobile computing device.

19. The computing device of claim 18, wherein the low-power processor device is utilized when the computing device is operating in the intermediate operating domain.

20. One or more computer-readable media that collectively store instructions that, when executed by one or more of a plurality of processor devices of a computing device, cause the computing device to perform operations, the operations comprising:
causing, with a low-power processor device of the plurality of processor devices, display of a low-power operating domain interface via a display device associated with the computing device;
making, with the low-power processor device, a determination that a user of the computing device intends a particular type of interaction with the computing device that requires the computing device to operate in a high-performance operating domain that utilizes a high-performance processor device of the plurality of processor devices;
responsive to the determination, performing, with the low-power processor device, one or more initial domain-switching processes of a plurality of domain-switching processes that are performed to switch the computing device to the high-performance operating domain; and
responsive to the determination, causing, with the low-power processor device, display of a high-performance operating domain interface via the display device associated with the computing device.
